(19) United States
(12) Patent Application Publication
(10) Pub. No.: US 2019/0219482 A1
(43) Pub. Date: Jul. 18, 2019

(54) METHOD FOR MONITORING A MAGNETIC BEARING APPARATUS

(71) Applicant: SIEMENS AKTIENGESELLSCHAFT, Munchen (DE)

(72) Inventor: Bert-Uwe Köhler, Falkensee (DE)

(73) Assignee: SIEMENS AKTIENGESELLSCHAFT, Munchen (DE)

(21) Appl. No.: 16/247,160

(22) Filed: Jan. 14, 2019

(30) Foreign Application Priority Data
Jan. 15, 2018 (EP) 18151631.1

(51) Int. Cl. G01M 13/04

(52) U.S. Cl. CPC G01M 13/04; F16C 32/0406

(57) ABSTRACT

In a method for monitoring a magnetic bearing apparatus a first pair of at least essentially diametrically opposed sensors and a second pair of at least essentially diametrically opposed sensors are arranged in offset relation about an angle. A distance of each of the sensors from a rotating body arranged inside the first and second pairs of sensors is determined by temporal averaging of a plurality of distance measurements. The distances of the sensors from the rotating body are compared and a warning signal is outputted when a difference in the distances exceeds a limit value.

### CROSS-REFERENCES TO RELATED APPLICATIONS

This application claims the priority of European Patent Application, Serial No. 18151631.1, filed Jan. 15, 2018, pursuant to 35 U.S.C. 119(a)-(d), the disclosure of which is incorporated herein by reference in its entirety as if fully set forth herein.

### BACKGROUND OF THE INVENTION

The present invention generally relates to the field of monitoring a magnetic bearing apparatus.

The following discussion of related art is provided to assist the reader in understanding the advantages of the invention, and is not to be construed as an admission that this related art is prior art to this invention.

A method for monitoring a magnetic bearing apparatus is used, in particular, in an active magnetic bearing of a fast-rotating electrical rotating machine, for example, a motor, a generator, a compressor or a turbine. As a non-limiting example, a fast-rotating electrical rotating machine may be involved that can be operated with a power of at least 1 megawatt and a rotational speed of at least 5,000 rpm.

A position of an active magnetic bearing is controlled with the aid of position measured values relating to the position of the rotating body. The rotating body is, for example, a rotor of the electrical rotating machine. The position measured values are acquired with distance sensors. If a sensor fails or the sensor delivers incorrect measured values, the position control is no longer capable of keeping the rotating body in the correct position. To monitor integrity of the magnetic bearing apparatus in the electrical rotating machine, it is necessary to permanently check the functionality of the position sensors and determination of the position as a whole and, when a malfunction is discovered, to transfer the electrical rotating machine into a safe state.

Since the position control controls to a target point on the basis of the position measured values at hand, the integrity of the position measured values, which are used for control, cannot be determined solely from the position measured values.

It would therefore be desirable and advantageous to obviate prior art shortcomings and to improve monitoring of determination of the position of a rotating body in an active magnetic bearing.

### SUMMARY OF THE INVENTION

According to one aspect of the present invention, a method for monitoring a magnetic bearing apparatus includes arranging a first pair of at least essentially diametrically opposed sensors and a second pair of at least essentially diametrically opposed sensors in offset relation about an angle, determining a distance of each of the sensors from a rotating body arranged inside the first and second pairs of sensors by temporal averaging of a plurality of distance measurements, comparing the distances of the sensors from the rotating body, and outputting a warning signal when a difference in the distances exceeds a limit value.

The present invention resolves prior art problems by linking a sensor evaluation of two independently controlled sensor axes, which are arranged mutually offset about an angle, with the other pair of distance sensors respectively and thereby carrying out a consistency check of the sensor data. The active magnetic bearing is designed as a radial bearing and/or as an axial bearing. A consistency check is to be understood as relating, for example, to checking of the sensor data in respect of its integrity. The sensor data is, for example, not consistent when a distance sensor fails, or, for example, due to a sensor drift, delivers incorrect measured values, so that as a result of such an inconsistency, a correct position of the rotating body can no longer be maintained.

During the consistency check the distances of the sensors from the rotating body respectively are determined by temporal averaging of a plurality of distance measurements. The temporal averages of the distances are compared with each other. There is an inconsistency in the sensor data when there is a difference in the distances, wherein a warning signal is outputted as soon as the difference in distance exceeds a limit value. The limit value should be selected such that faulty activation is avoided but a collision of the rotating body with, for example, a safety bearing is still reliably prevented. The warning signal can be an acoustic, optical and/or electrical signal, wherein in case of a warning signal the electrical rotating machine is, for example, transferred into a safe state. The electrical rotating machine may, for example, be a motor, a generator, a compressor or a turbine. In particular, the electrical rotating machine can be operated with a power of at least 1 megawatt and a rotational speed of at least 5,000 rpm.

A thermal expansion that occurs due to build-up of heat in particular in the rotor during operation of the electrical rotating machine is not a problem with a consistency check of this kind since the thermal expansion occurs at least essentially uniformly in the radial direction and there is no comparison of absolute values and instead the sensors are considered relative to each other. The probability of a false alarm is therefore significantly reduced.

The combined evaluation of the two sensor axes enables sensor monitoring without additional sensors. The consistency check of the sensor data can therefore be implemented inexpensively and effectively.

According to another advantageous feature of the present invention, provision can be made for checking whether a control is settled by comparing the distances of the first pair of sensors from the rotating body and comparing the distances of the second pair of sensors from the rotating body. A check as to whether the control is in a stable state reduces a number of error sources for the consistency check, so the probability of a false alarm is also reduced.

According to another advantageous feature of the present invention, provision can be made for comparing, when the control has settled, a first distance of a one of the sensors of the first pair of sensors and/or a second distance of the other one of the sensors of the first pair of sensors with a third distance of one of the sensors of the second pair of sensors and/or a fourth distance of the other one of the sensors of the second pair of sensors, with the warning signal being output when the difference in the distances exceeds the limit value. In particular, a position of the rotating body can be controlled by the magnetic bearing such that the difference in the distances of a pair of sensors is zero. When the control is settled, at least one distance value of the first pair of sensors, which is associated with the first sensor axis, is compared with at least one distance value of the second pair of sensors, which is associated with the second sensor axis. This combined use of the two sensor axes enables sensor monitoring without additional sensors, so sensor monitoring can be implemented inexpensively and effectively.

According to another advantageous feature of the present invention, the sensors of the first and second pairs of sensors can be configured as inductive displacement sensors so as to detect the distances contactlessly. An inductive displacement sensor is also called an eddy current sensor. Sensors of this kind are very accurate, inexpensive and reliable.

According to another advantageous feature of the present invention, the second pair of sensors can be arranged rotated about an angle of 60° to 120° in relation to the first pair of the sensors. This kind of arrangement of the sensor axes facilitates an evaluation of the measurements.

According to another advantageous feature of the present invention, the rotating body can have an at least essentially circular cross-section. A circular cross-section produces, in particular with high rotational speeds, for example, of at least 5,000 rpm, optimum rotation properties. Furthermore, an evaluation of the measurements is facilitated since, with a circular cross-section, the distances from the sensor do not change during rotation.

According to another advantageous feature of the present invention, a redundant sensor can be arranged in a region of each one of the sensors of the first and second pairs of sensors, and a distance of the redundant sensor from the rotating body can be determined. A defective sensor can be detected, beyond the inconsistency of the sensors, by at least one additional sensor.

According to another advantageous feature of the present invention, the presence of a defective one of the sensors of the first and second pairs of sensors can be detected by comparing the distances of the sensors from the rotating body. Since essentially identical boundary conditions apply for the sensors of the affected axis and the closest adjacent redundant sensor in respect of the distance from the rotating body, a comparison of the distances of the closest adjacent sensors can in particular detect an axis with a defective sensor, and by changing over the control from the sensor adjacent to the redundant sensor to the redundant sensor, the defective sensor itself can be detected. A downtime of the electrical rotating machine is reduced and thereby the availability of the machine is improved by such direct identification of a defective sensor without further measurements.

According to another aspect of the present invention, a control unit includes a programmable logic module, and a computer program embodied in a non-transitory computer readable medium, wherein the computer program, when loaded into the programmable logic module and executed by the programmable logic module, causes the programmable logic module to perform a method according to the present invention.

The process sequence relating to the consistency check of the sensor data is thus controlled by a control unit. The method is executed by a computer program and, for example, a microcontroller or a different programmable logic module. The control unit can be arranged, for example, in the sensor device.

According to still another aspect of the present invention, a sensor device includes a control unit, and at least four sensors operably connected to the control unit and configured to determine a distance of each of the sensors from a rotating body by temporal averaging of a plurality of distance measurements.

According to yet another aspect of the present invention, a magnetic bearing apparatus includes a magnetic bearing, and a sensor device for monitoring the magnetic bearing, with the sensor device being configured as set forth above.

According to yet another aspect of the present invention, an electrical rotating machine includes a magnetic bearing apparatus as set forth above and a sensor device for monitoring the magnetic bearing.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a longitudinal section of an electrical rotating machine according to the present invention;

FIG. 2 shows a cross-section through a magnetic bearing apparatus, taken along the section line II-II in FIG. 1, depicting a first embodiment of a sensor device; and

FIG. 3 shows a cross-section through a magnetic bearing apparatus with a second embodiment of a sensor device.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

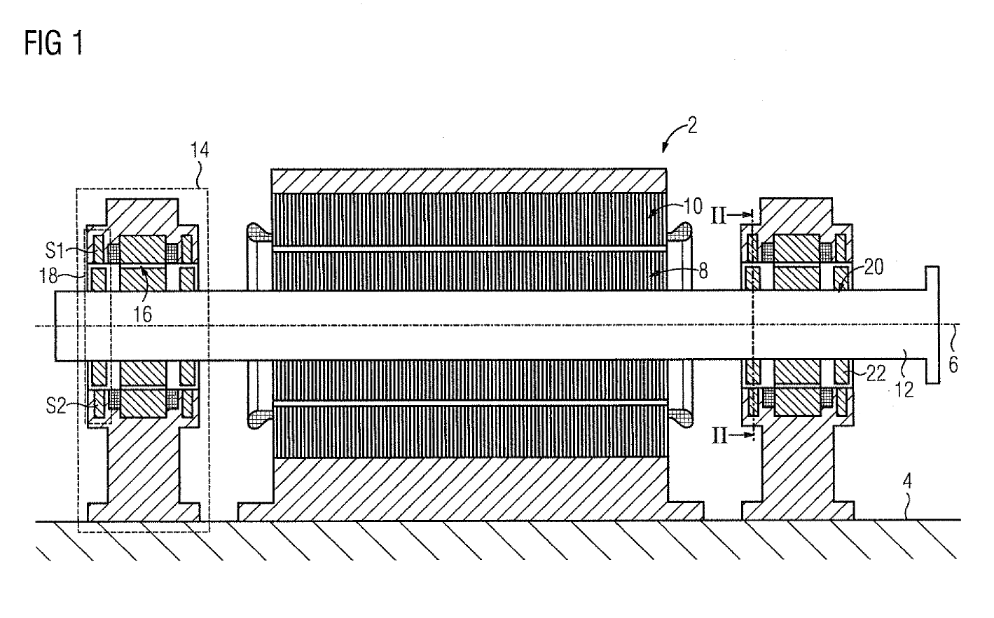

Turning now to the drawing, and in particular to FIG. 1, there is shown a longitudinal section of an electrical rotating machine according to the present invention, generally designated by reference numeral 2. The electrical rotating machine 2 stands on a base 4 and is designed as a motor or as a generator and has a rotor 8 which can rotate about an axis of rotation 6, and a stator 10 which surrounds the rotor 8. A shaft 12 of the rotor 8 is contactlessly mounted at the two axial ends by one active magnetic bearing apparatus 14 respectively. Alternatively, the electrical rotating machine 2 is designed as a compressor or turbine with a shaft 12 which is contactlessly mounted at the axial ends by one active magnetic bearing apparatus 14 respectively.

A position of a rotating body 20 is determined by a sensor device 18, wherein the rotating body 20 comprises the rotor 8 with the shaft 12. In the region of the sensor device 18 the rotating body 20 optionally has a sensor ring 22 which is connected to the shaft 12. For example, the sensor ring 22 is connected to the shaft 12 by material bonding or is shrunk onto the shaft 12. The rotating body 20 has an at least essentially circular cross-section.

The sensor device comprises sensors S1, S2 arranged around the circumference of the shaft 12, and these are designed as inductive displacement sensors and are capable of contactlessly detecting distances of the rotating body 20 from the respective sensors S1, S2. The inductive displacement sensors are used, for example, to measure via an air gap an impedance and preferably a change in the impedance.

The magnetic bearing apparatus 14 is designed by way of example as a radial bearing. Use of the sensor device 18 for an axial bearing is likewise a subject matter of the patent application, wherein in the case of an axial bearing, the sensor device 18 is provided for determining the position of the rotating body 20 in the axial direction.

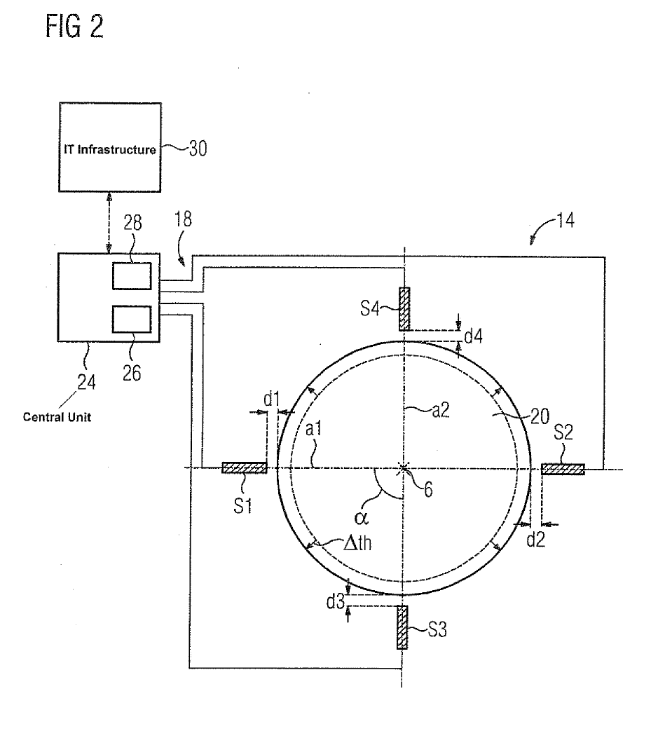

FIG. 2 shows a cross-section through a magnetic bearing apparatus 14, taken along the section line II-II in FIG. 1, depicting a first embodiment of a sensor device 18, wherein a rotating body 20 is contactlessly mounted by the magnetic bearing apparatus 14. The sensor device 18 comprises two pairs of the diametrically opposed sensors S1, S2, S3, S4, which each form an axis a1, a2, wherein the second axis a2 of the second pair S3, S4 is arranged rotated about an angle α in the region of 90° in relation to the first axis a1 of the first pair S1, S2. The sensors S1, S2, S3, S4 are connected to a central unit 24 which comprises an evaluation unit 26 and a control unit 28. The measured sensor data is transmitted to the central unit 24, for example electrically, in particular in a wired manner, or optically via optical fibers. The sensors S1, S2, S3, S4 are designed as inductive displacement sensors by which the distances d1, d2, d3, d4 respectively of the respective sensor S1, S2, S3, S4 from the rotating body 20 are contactlessly detected. The determined data is digitized and at least partially sent to an IT infrastructure 30. An IT infrastructure 30 is, for example, at least one local computer system or a cloud, and provides storage space, computing power and application software. Storage space, computing power and application software are provided in a cloud as a service via the Internet. Data is digitally transmitted wirelessly, in a wired manner or optically to the IT infrastructure 30. For example, the data is transmitted via Bluetooth or WLAN.

The pair of sensors S1, S2, S3, S4 of the respective axes a1, a2 have different controllers which are not shown in FIG. 2 for reasons of simplicity. The position measured values of the sensors S1, S2, S3, S4 are used for control. The distances d1, d2, d3, d4 are controlled such that d2−d1=0 and d4−d3=0 results. The sensors are calibrated such that the target position corresponds to a zero displacement. After calibration d1=d2=d3=d4 applies, therefore.

Firstly, a comparison of the distances d1, d2 of the first pair of sensors S1, S2 and a comparison of the distances d3, d4 of the second pair of sensors 83, S4 checks whether a control is settled.

If the control is settled, in other words, d1=d2 and d3=d4 apply, a consistency check of the sensor data of the two axes a1, a2 is carried out: a first distance d1 of the first sensor S1 and/or a second distance d2 of the second sensor S2 is/are compared with a third distance d3 of the third sensor S3 and/or a fourth distance d4 of the fourth sensor S4, wherein a warning signal is output as soon as a difference in the distances d1, d2, d3, d4 exceeds a limit value. Since d1=d2 and d3=d4 applies, it is sufficient to compare one of the distances d1, d2 of the first pair of sensors S1, S2 with one of the distances d3, d4 of the second pair of sensors S3, S4. Alternatively, all distances d1, d2, d3, d4 are compared as to whether d1=d2=d3=d4 applies.

During operation, a thermal rotor expansion Δth occurs, in other words, due to heating of the rotor 8, a diameter of the rotating body 20 increases slightly but uniformly. The thermal rotor expansion Δth is not a problem, however, because the distances d1, d2, d3, d4 of the sensors S1, S2, S3, S4 are compared with each other and there is no comparison of the absolute values. An application to axial bearings is possible. The further design of the magnetic bearing apparatus 14 in FIG. 2 matches that in FIG. 1.

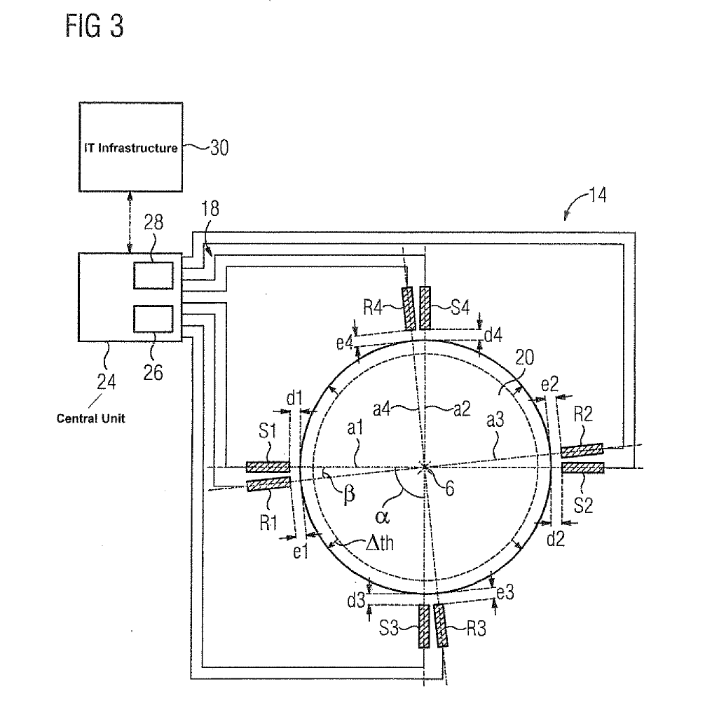

FIG. 3 shows a cross-section through a magnetic bearing apparatus 14 with a second embodiment of a sensor device 18. One redundant sensor R1, R2, R3, R4 respectively is associated with the sensors S1, S2, S3, S4 in order to also directly detect a defective sensor beyond a possible inconsistency of the sensors. The redundant sensors R1, R2, R3, R4 are arranged diametrically opposed in pairs, with the pairs each forming one axis respectively. The axes a3, a4 of the redundant sensors R1, R2, R3, R4 are arranged rotated about an offset angle β in the region of up to 10° in relation to the axes a1, a2 of the sensors S1, S2, S3, S4. Essentially identical boundary conditions apply to the sensors S1, S2, S3, S4 and their closest adjacent redundant sensors R1, R2, R3, R4 in respect of the distance from the rotating body 20.

The distances e1, e2, e3, e4 of the redundant sensors R1, R2, R3, R4 from the rotating body 20 are determined, wherein a defective sensor S1, S2, S3, S4, R1, R2, R3, R4 is detected by way of a comparison of the determined distances d1, d2, d3, d4, e1, e2, e3, e4. The further design of the magnetic bearing apparatus 14 in FIG. 3 matches that in FIG. 2.

To summarize, the invention relates to a method for monitoring a magnetic bearing apparatus 14. To improve monitoring of determination of the position of a rotating body in an active magnetic bearing, it is proposed that the magnetic bearing apparatus 14 has a first pair of at least essentially diametrically opposed sensors S1, S2 and a second pair of at least essentially diametrically opposed sensors S3, S4, which are arranged offset to the first pair sensors S1, S2 about an angle α, wherein one distance d1, d2, d3, d4 respectively of a sensor S1, S2, S3, S4 from a rotating body 20, which is arranged inside the pair of sensors S1, S2; S3, S4, is determined by temporal averaging of a plurality of distance measurements, wherein the distances d1, d2, d3, d4 are compared, wherein a warning signal is output as soon as a difference in the distances d1, d2, d3, d4 exceeds a limit value.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for monitoring a magnetic bearing apparatus, comprising:
arranging a first pair of at least essentially diametrically opposed sensors and a second pair of at least essentially diametrically opposed sensors in offset relation about an angle;
determining a distance of each of the sensors from a rotating body arranged inside the first and second pairs of sensors by temporal averaging of a plurality of distance measurements;
comparing the distances of the sensors from the rotating body; and
outputting a warning signal when a difference in the distances exceeds a limit value.

2. The method of claim 1, further comprising checking whether a control is settled by comparing the distances of the first pair of sensors from the rotating body and comparing the distances of the second pair of sensors from the rotating body.

3. The method of claim 2, further comprising comparing, when the control has settled, a first distance of a one of the sensors of the first pair of sensors and/or a second distance of the other one of the sensors of the first pair of sensors with a third distance of one of the sensors of the second pair of sensors and/or a fourth distance of the other one of the sensors of the second pair of sensors, with the warning signal being output when the difference in the distances exceeds the limit value.

4. The method of claim 1, further comprising configuring the sensors of the first and second pairs of sensors as inductive displacement sensors so as to detect the distances contactlessly.

5. The method of claim 1, wherein the second pair of sensors is arranged rotated about an angle of 60° to 120° in relation to the first pair of the sensors.

6. The method of claim 1, wherein the rotating body has an at least essentially circular cross-section.

7. The method of claim 1, further comprising:
arranging a redundant sensor in a region of each one of the sensors of the first and second pairs of sensors; and
determining a distance of the redundant sensor from the rotating body.

8. The method of claim 7, further comprising detecting the presence of a defective one of the sensors of the first and second pairs of sensors by comparing the distances of the sensors from the rotating body.

9. A control unit, comprising:
a programmable logic module; and
a computer program embodied in a non-transitory computer readable medium, wherein the computer program, when loaded into the programmable logic module and executed by the programmable logic module, causes the programmable logic module to perform the steps of:
arranging a first pair of at least essentially diametrically opposed sensors and a second pair of at least essentially diametrically opposed sensors in offset relation about an angle;
determining a distance of each of the sensors from a rotating body arranged inside the first and second pairs of sensors by temporal averaging of a plurality of distance measurements;
comparing the distances of the sensors from the rotating body; and
outputting a warning signal when a difference in the distances exceeds a limit value.

10. A computer program embodied in a non-transitory computer readable medium, wherein the computer program, when loaded into a control unit and executed by the control unit, causes the control unit to perform the steps of:
arranging a first pair of at least essentially diametrically opposed sensors and a second pair of at least essentially diametrically opposed sensors in offset relation about an angle;
determining a distance of each of the sensors from a rotating body arranged inside the first and second pairs of sensors by temporal averaging of a plurality of distance measurements;
comparing the distances of the sensors from the rotating body; and
outputting a warning signal when a difference in the distances exceeds a limit value.

11. A computer program product, comprising:
a control unit; and a
a computer program embodied in a non-transitory computer readable medium, wherein the computer program, when loaded into the control unit and executed by the control unit, causes the control unit to perform the steps of:
arranging a first pair of at least essentially diametrically opposed sensors and a second pair of at least essentially diametrically opposed sensors in offset relation about an angle;
determining a distance of each of the sensors from a rotating body arranged inside the first and second pairs of sensors by temporal averaging of a plurality of distance measurements;
comparing the distances of the sensors from the rotating body; and
outputting a warning signal when a difference in the distances exceeds a limit value.

12. A sensor device, comprising:
a control unit; and
at least four sensors operably connected to the control unit and configured to determine a distance of each of the sensors from a rotating body by temporal averaging of a plurality of distance measurements.

13. A magnetic bearing apparatus, comprising:
a magnetic bearing; and
a sensor device for monitoring the magnetic bearing, said sensor device comprising a control unit, and at least four sensors operably connected to the control unit and configured to determine a distance of each of the sensors from a rotating body by temporal averaging of a plurality of distance measurements.

14. An electrical rotating machine, comprising a magnetic bearing apparatus which includes a magnetic bearing, and a sensor device for monitoring the magnetic beating, said sensor device comprising a control unit, and at least four sensors operably connected to the control unit and configured to determine a distance of each of the sensors from a rotating body by temporal averaging of a plurality of distance measurements.
